(19) United States
(12) Patent Application Publication
(10) Pub. No.: US 2026/0023259 A1
(43) Pub. Date: Jan. 22, 2026

(54) METHOD FOR DESIGNING DIFFRACTIVE DEVICE AND METHOD FOR MANUFACTURING DIFFRACTIVE DEVICE

(71) Applicant: NTT, Inc., Tokyo (JP)

(72) Inventors: Masahiro Ueno, Tokyo (JP); Sohan Kawamura, Tokyo (JP); Takashi Sakamoto, Tokyo (JP); Masayuki Tsuda, Tokyo (JP)

(21) Appl. No.: 19/101,740

(22) PCT Filed: Aug. 9, 2022
(86) PCT No.: PCT/JP2022/030398

§ 371 Date: Feb. 6, 2025

(51) Int. Cl. G02B 27/00; G02B 5/18

(52) U.S. Cl. CPC G02B 27/0012; G02B 5/1847

(57) ABSTRACT

An embodiment is a method for designing a diffractive element which phase-modulates incident light including determining an electric field distribution on an emission plane with respect to a spherical wave condensed in a range between a first distance and a second distance from the emission plane, calculating a first electric field distribution as the electric field distribution on the emission plane by multiplying Exp[−jkz cos φ_{B}] by the electric field distribution for the spherical wave and integrating over the range, where z is a coordinate on a straight line, k is the wave number of emitted light, and φ_{B} is a convergence angle between the emitted light and the straight line, and determining a depth of an unevenness on a surface of the diffractive element based on the calculated electric field distribution.

### CROSS-REFERENCE TO RELATED APPLICATIONS

This application is a national phase entry of PCT Application No. PCT/JP2022/030398, filed on Aug. 9, 2022, which application is hereby incorporated herein by reference.

### TECHNICAL FIELD

The present invention relates to a method for designing a diffractive device used for laser processing, rust removal and the like, and a method for manufacturing the same.

### BACKGROUND

A high power laser device is used in wide ranged such as a laser processing device for performing cutting, welding, and printing on metals, resins or the like, and a rust removal laser device for removing rust from metals. In the high power laser device, there is a problem of miniaturization and weight reduction of a portion which scans the emitted light, a so-called head portion. Therefore, attempts have been made to use a diffractive element (DOE, hereinafter referred to as a “diffractive element” or “DOE”) in the head portion of a laser processing device.

In particular, a kinoform is a diffractive element that only modulates the light phase and does not change the light intensity. Here, one of such having an unevenness structure on the surface of the substrate will be described.

FIG. 10 is a schematic view of an optical system in a case where an image is formed, using a diffractive element 40 of the related art. Light incident on the diffractive element 40 (arrow 1 in the drawing indicates an incident direction) is emitted from an emission plane Po of the diffractive element 40, and the light emitted from the diffractive element 40 (an arrow 2 in the drawing indicates an emission direction) is condensed (image-formed) on an image formation plane P₁.

Here, P₀ and P₁ are assumed to be parallel. In addition, it is assumed that an x-axis, a y-axis and a z-axis in the drawing are axes of a Cartesian coordinate system, and the coordinate origin is at P₀. The z-axis is an optical axis, and substantially coincides with a direction in which light emitted from the DOE 40 travels. The x-axis and the y-axis are orthogonal to the z-axis, and the xy plane is parallel to the P₀ plane and the P₁ plane. That is, the z-axis is orthogonal to the P₀ plane and the P₁ plane. In the drawing, u0 and u1 represent electric field distributions on P₀ and P₁, respectively.

When a z coordinate on P0 is defined as z₀=0 and a z coordinate on P₁ is defined as z₁, a relation between u₀ and u₁ is expressed by equation (1) from the expression of Kirchhoff's diffractive integral (for example, NPL 1).

$$\begin{matrix}[ Math . 1 ] & \\ {u}_{1} ( {x}_{1} , {y}_{1} ) = \frac{j}{λ} \int {\int }_{- ∞}^{+ ∞} {u}_{0} ( {x}_{0} , {y}_{0} ) \cdot g ( {x}_{1} - {x}_{0} , {y}_{1} - {y}_{0} , {z}_{1} - {z}_{0} ) {dx}_{0} {dy}_{0} & ( 1 )\end{matrix}$$

In the equation, (xₒ, yₒ, zₒ) and (x₁, y₁, z₁) are sets of coordinates of points on Pₒ and P₁, j is an imaginary number unit, and λ is a wavelength of light. In addition, g(·) is a propagation function of light emitted from one point and is expressed by equations (2) to (4).

$$\begin{matrix}[ Math . 2 ] & \\ g ( x , y , z ) = \frac{1 + cos θ}{2} \cdot \frac{{e}^{- jkr}}{r} & ( 2 )\end{matrix}$$

$$\begin{matrix}[ Math . 3 ] & \\ r = \sqrt{{x}^{2} + {y}^{2} + {z}^{2}} & ( 3 )\end{matrix}$$

$$\begin{matrix}[ Math . 4 ] & \\ cos θ = \frac{z}{r} & ( 4 )\end{matrix}$$

Here, j is an imaginary number unit, and k is a wavenumber of light. Here, (1+cos θ)/2 is an inclination factor, which indicates an emission angle dependency from a DOE emission plane to the electric field intensity on each point on an image formation plane.

Since a right side of equation (1) is a convolution integral of u₀ and g, when performing the Fourier transform on both sides of equation (1), it is expressed by equation (5).

$$\begin{matrix}[ Math . 5 ] & \\ {U}_{1} ( u , v ) = \frac{j}{λ} \cdot {U}_{0} ( u , v ) \cdot G ( u , ν ) & ( 5 )\end{matrix}$$

Here, each of U₁, U₀ and G is the Fourier transform of u₁, u₀, and g, and each of u and v represents spatial frequencies in the x-axis and y-axis direction.

U0 from equation (5) is represented by equation (6).

$$\begin{matrix}[ Math . 6 ] & \\ {U}_{0} ( u , v ) = - j λ \cdot \frac{{U}_{1} ( u , v )}{G ( u , v )} & ( 6 )\end{matrix}$$

When both sides of equation (6) are subjected to inverse Fourier transform, u0 can be derived as shown in equation (7).

$$\begin{matrix}[ Math . 7 ] & \\ {u}_{0} ( x , y ) = - j λ \cdot {ℱ}^{- 1} [ \frac{{U}_{1} ( u , v )}{G ( u , v )} ] = - j λ \cdot {ℱ}^{- 1} [ \frac{ℱ [ {u}_{1} ( x , y ) ]}{ℱ [ g ( x , y ) ]} ] & ( 7 )\end{matrix}$$

Here, F[·] and F⁻¹[·] represent Fourier transform and inverse Fourier transform, respectively.

In this way, if the electric field distribution u₁ on the image formation plane P₁ and the z-axis coordinate value z₁ of the image formation plane P₁ are specified, the electric field distribution u0 on the DOE emission plane P₀ can be calculated.

Next, a method for designing unevenness formed on the surface of the DOE 40 using the electric field distribution u0 on the DOE emission plane P0 will be described.

Here, it is assumed that the DOE 40 is of a transmission type, the DOE 40 is a dielectric of a rectangular parallelepiped having a uniform refractive index distribution, an unevenness shape on the DOE 40 is formed on one side of the dielectric of the rectangular parallelepiped, and square or rectangular pixels are arranged in a lattice shape.

The light is made incident from a surface on which the unevenness is formed or from its opposite surface, and the light is emitted from the surface opposite to the incident surface. In such DOE 40, an electric field distribution u0 on the DOE emission plane P₀ is formed by the thickness of a dielectric in each pixel (optical path length from an incident surface to an emission plane). Here, a case where the amplitude modulation of the electric field is not performed and only the phase modulation is performed (kinoform) in the DOE will be described.

FIG. 11 shows a relationship between the thickness of the transmission type DOE 40 and the phase of light on the DOE emission plane 42. A DOE internal refractive index is defined as n1, and a DOE external refractive index is defined as no (1 in air). Further, a level difference of the unevenness of the surface of the DOE 40 is defined as d, and the DOE 40 in the optical path A43 is made thinner by the level difference (thickness) d than the DOE 40 in the optical path B44. A point b is a point on the optical axis on the DOE emission plane 42 of the optical path B44, and a point a is an intersection point between a surface including the emission plane 42 of the optical path B44 and the optical axis of the optical path A43. A dotted line in the drawing indicates an equiphase plane 45 between the optical paths A43 and B44.

As shown in FIG. 11, when a plane wave is incident (in a direction of arrow 46), a phase difference Δφ at the point a when the phase at point b is defined as a reference (=0) is expressed by equation (8).

$$\begin{matrix}[ Math . 8 ] & \\ Δφ = - {k}_{0} d - ( - {k}_{1} d ) = d ( {k}_{1} - {k}_{0} ) = d ( \frac{2 π}{{λ}_{1}} - \frac{2 π}{{λ}_{0}} ) = \frac{2 π}{λ} d ( {n}_{1} - {n}_{0} ) & ( 8 )\end{matrix}$$

In this case, k1 and k0 are wavenumbers of light in the DOE 40 and outside the DOE 40, λ₁and λ₀ are wavelengths of light inside the DOE 40 and outside the DOE 40, respectively, and λ is a wavelength of light in a vacuum.

When solving equation (8) with respect to d, it is represented by equation (9).

$$\begin{matrix}[ Math . 9 ] & \\ d = \frac{Δφ}{( {k}_{1} - {k}_{0} )} = \frac{λ}{2 π ( {n}_{1} - {n}_{0} )} Δφ & ( 9 )\end{matrix}$$

If the light incident on the DOE incident surface 41 is a plane wave, the phase of the DOE emission plane 42 is determined by an amount of depression (level difference of unevenness) d from the DOE emission plane 42. Since the phase difference Δφ of u₀ can be represented by a deflection angle arg (u₀) of u₀, the phase difference is represented by equation (10).

$$\begin{matrix}[ Math . 10 ] & \\ d ( x , y ) = \frac{arg ( {u}_{0} ( x , y ) )}{( {k}_{1} - {k}_{0} )} = \frac{λ}{2 π ( {n}_{1} - {n}_{0} )} arg ( {u}_{0} ( x , y ) ) & ( 10 )\end{matrix}$$

Here, since u0 fluctuates on an xy plane, the amount of depression (level difference of unevenness) from the DOE emission plane 42 is expressed by d (x, y).

When the thickness from the DOE incident surface 41 to the DOE emission plane 42 (thickness which becomes a reference of DOE 40) is defined as Lₒ, the thickness L (x, y) of the DOE 40 is expressed by equation (11).

$$\begin{matrix}[ Math . 11 ] & \\ L ( x , y ) = {L}_{0} - d ( x , y ) & ( 11 )\end{matrix}$$

Here, since arg (u₀) is usually in the range of 0 to 2π and −π to +π, d is 0 to λ/(n1−n0) and −λ/[2(n1−n0)] to +λ/[2(n1−n0)], respectively.

Since −jλ included in u0 represented by equation (7) is a constant, u0 represented by equation (12) may be used instead of u0 represented by equation (7).

$$\begin{matrix}[ Math . 12 ] & \\ {u}_{0}^{′} ( x , y ) = {ℱ}^{- 1} [ \frac{{U}_{1} ( u , v )}{G ( u , ν )} ] = {ℱ}^{- 1} [ \frac{ℱ [ {u}_{1} ( x , y ) ]}{ℱ [ g ( x , y ) ]} ] & ( 12 )\end{matrix}$$

### CITATION LIST

### Non Patent Literature

[NPL 1] Joseph W. Goodman, “Introduction to Fourier Optics Second Edition”, McGROW-Hill Companies Inc., 1996, pp. 32-53.

### SUMMARY

### Technical Problem

However, in the method for designing the unevenness formed on the surface of the DOE, since an image formation plane on which the electric field generated by the DOE can be designed to be is only the one surface P₁ and an emission range of light on the DOE emission plane Po forming a bright spot on the image formation plane P₁ is the whole surface of the DOE emission plane, it is not possible to perform design such that a diameter of the bright spot on the image formation plane P₁ can be maintained at a desired length in the optical axis direction.

Therefore, when the diffractive element designed by the above method is used for laser processing, rust removal or the like, the beam diameter cannot be held when the focal point of the beam is deviated in the optical axis direction. Thus, the accuracy of laser processing, the rust removal or the like is reduced, which causes a problem.

### Solution to Problem

In order to solve the above problem, a method for designing a diffractive element according to embodiments of the present invention is a method of designing a diffractive element which phase-modulates incident light using a computer, the method including: determining an electric field distribution on an emission plane with respect to a spherical wave condensed in a range between a first distance and a second distance from the emission plane, on a straight line perpendicular to the emission plane of the diffractive element; calculating a first electric field distribution as the electric field distribution on the emission plane of the diffractive element, by multiplying Exp[−jkz cos φB] when a coordinate on a straight line is z, the wavenumber of emitted light from the emission plane is k, and a convergence angle that the emitted light makes with the straight line is φB by the electric field distribution on the emission plane for the spherical wave, and by integrating over the range; and determining a depth of an unevenness on a surface of the diffractive element on the basis of the electric field distribution on the emission plane of the diffractive element.

The method for designing the diffractive element according to embodiments of the present invention is a method for designing a diffractive element which phase-modulates incident light using a computer, the method including: determining an electric field distribution on an emission plane with respect to a spherical wave condensed in a range between a first distance and a second distance from the emission plane, on a straight line perpendicular to the emission plane of the diffractive element; calculating a first electric field distribution as the electric field distribution on the emission plane of the diffractive element, by multiplying Exp [−jkz cos φB] when a coordinate on a straight line is z, the wave number of an emitted light from the emission plane is k, and a convergence angle that the emitted light makes with the straight line is φB by the electric field distribution on the emission plane for the spherical wave, and by adding over the range; and determining a depth of an unevenness on a surface of the diffractive element on the basis of the electric field distribution on the emission plane of the diffractive element.

### Advantageous Effects

According to embodiments of the present invention, it is possible to provide a design method and a manufacturing method for a diffractive element capable of holding a diameter and power of emitted light at a predetermined length in a light propagation direction, and capable of performing the processing and rust removal of an object having a depth by the emitted light with high accuracy.

### BRIEF DESCRIPTION OF THE DRAWINGS

FIG. 1 is a diagram for explaining a method for designing a diffractive element according to a first embodiment of the present invention.

FIG. 2 is a diagram for explaining a method for designing a diffractive element according to a first embodiment of the present invention.

FIG. 3 is a flowchart for explaining the method for designing the diffractive element according to the first embodiment of the present invention.

FIG. 4 is a flowchart for explaining a method for designing a diffractive element according to a second embodiment of the present invention.

FIG. 5 is a diagram for explaining a method for designing the diffractive element according to the second embodiment of the present invention.

FIG. 6A is a diagram for explaining the effect of the method for designing the diffractive element according to the second embodiment of the present invention.

FIG. 6B is a diagram for explaining the effect of the method for designing the diffractive element according to the second embodiment of the present invention.

FIG. 7 is a diagram for explaining the effect of the method for designing the diffractive element according to the second embodiment of the present invention.

FIG. 8A is a diagram for explaining the effect of the method for designing the diffractive element according to the second embodiment of the present invention.

FIG. 8B is a diagram for explaining the effect of the method for designing the diffractive element according to the second embodiment of the present invention.

FIG. 9 is a flowchart for explaining a method for designing a diffractive element according to a third embodiment of the present invention.

FIG. 10 is a diagram for explaining a method for designing a diffractive element of the related art.

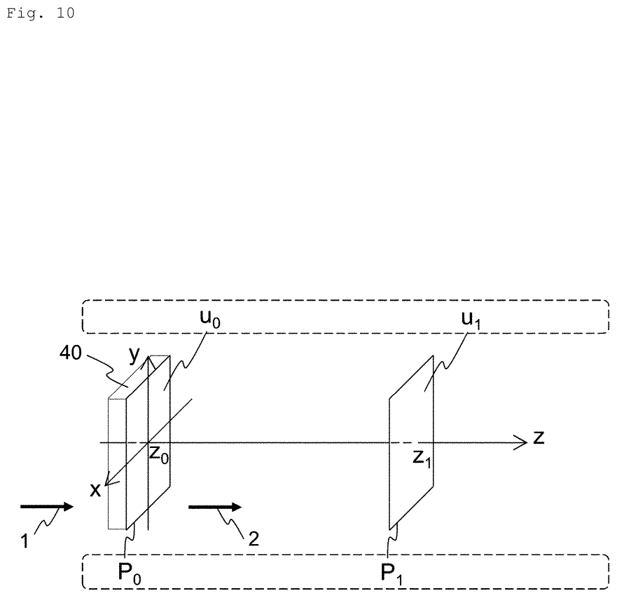

FIG. 11 is a diagram for explaining a method for designing a diffractive element of the related art.

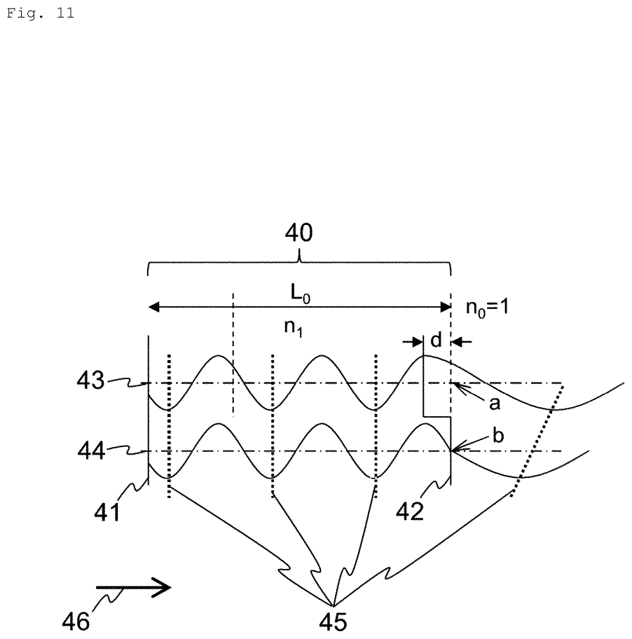

### DETAILED DESCRIPTION OF ILLUSTRATIVE EMBODIMENTS

### First Embodiment

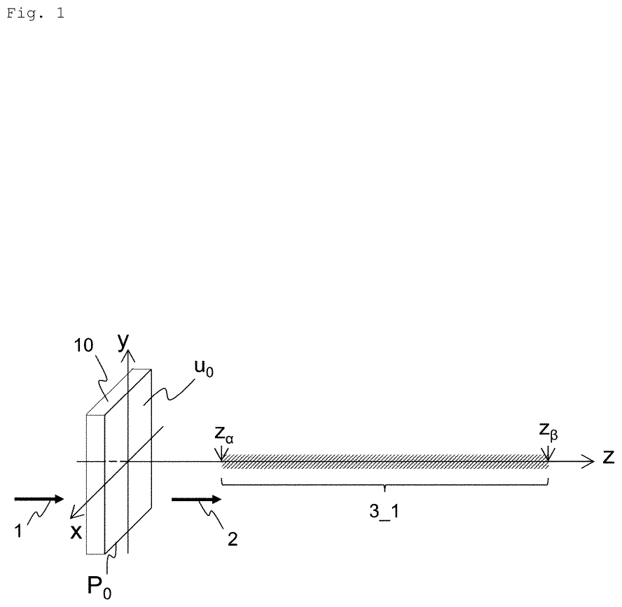

A method for designing a diffractive element and a method for manufacturing the same according to a first embodiment of the present invention will be described with reference to FIGS. 1 to 3.

A diffractive element 10 in the present embodiment is a so-called kinoform which does not perform an amplitude modulation of an electric field but performs only a phase modulation.

In the method for designing the diffractive element (DOE) 10 according to the present embodiment, an electric field distribution u0 (first electric field distribution) on the emission plane P₀ of the diffractive element 10 for condensing (imaging) light between two points (zα and zβ) on the z-axis is determined, and a surface structure (unevenness structure) of the diffractive element 10 is designed. Here, the z-axis of the xyz coordinate system is perpendicular to the DOE emission plane P₀.

FIG. 1 is a schematic view of an optical system in a case where an image is formed, using a diffractive element 10 in the present embodiment. Light incident on the diffractive element 10 (arrow 1 in the drawing indicates an incident direction) is emitted from the emission plane P₀ of the diffractive element 10, and emitted light from the diffractive element 10 (arrow 2 in the drawing indicates the emission direction) is condensed as a bright line 3_1 in a region between two points (Z_{α} and z_{β}) on the z-axis. Here, the light emitted from the diffractive element 10 has a first electric field distribution u0.

Here, x, y and z axes represent respective axes of a Cartesian coordinate system, and the DOE emission plane P₀ is parallel to the xy plane.

When the coordinates of an arbitrary point on the z-axis in FIG. 1 are defined as (0, 0, z1 ) and the coordinates of a certain point on the DOE emission plane are defined as (x, y, 0), the electric field distribution u_{0,z1}′ (x, y) on the DOE emission plane when focusing light on (0, 0, z1) is represented by equation (13) from equation (12).

$$\begin{matrix}[ Math . 13 ] & \\ {u}_{0 , {z}_{1}}^{′} ( x , y ) = {ℱ}^{- 1} [ \frac{ℱ [ {u}_{1} ( x , y ) ]}{ℱ [ g ( x , y ) ]} ] & ( 13 )\end{matrix}$$

Here, u1 (x, y) is an electric field distribution on a plane parallel to the DOE emission plane including (0, 0, z).

u1 (x, y) is actually expressed by a function having a predetermined spread (for example, a Gaussian function, a Bessel function, etc.). Here, in order to simplify the calculation, when u1 (x, y) is approximated by a δ function, u_{0,z1}′ (x, y) is represented by equation (14).

$$\begin{matrix}[ Math . 14 ] & \\ {u}_{0 , {z}_{1}}^{′} ( x , y ) = {ℱ}^{- 1} [ \frac{1}{ℱ [ g ( x , y ) ]} ] & ( 14 )\end{matrix}$$

From equation (13), as shown in FIG. 1, an electric field u0 (x, y) on the DOE emission plane when a set (bright line) of bright spots is condensed between z_{α} and z_{β} on the z-axis is approximated by Equation (15). Here, u_{0,z1}′ (x, y) is defined as u₀, z (x, y).

$$\begin{matrix}[ Math . 15 ] & \\ \begin{matrix}{u}_{0} ( x , y ) = {\int }_{{z}_{α}}^{{z}_{β}} {u}_{0 , z} ( x , y ) \cdot {e}^{- jkz cos {φ}_{B}} dz \\ = {\int }_{{z}_{α}}^{{z}_{β}} {ℱ}^{- 1} [ \frac{1}{ℱ [ g ( x , y ) ]} ] \cdot {e}^{- jkz cos {φ}_{B}} dz\end{matrix} & ( 15 )\end{matrix}$$

Equation (15) will be explained in detail below. First, a Bessel beam is considered as a beam for holding the beam spot diameter on the z-axis for a long distance.

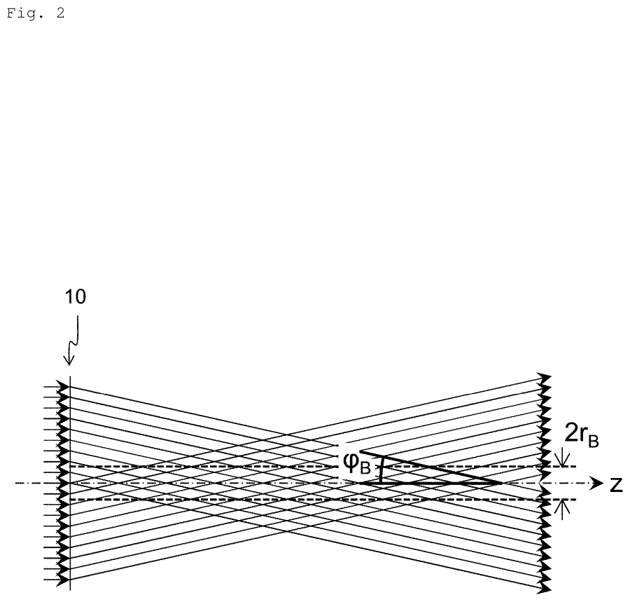

FIG. 2 shows the progress of light from the diffractive element (DOE) 10 when a Bessel beam having the z-axis as the center of the main lobe is formed. The Bessel beam is formed when light propagates of the same angle φ_{B} (hereinafter referred to as “convergence angle”) around the z-axis. The Bessel beam has a main lobe and a side lobe, and the center of the z-axis is the center of the main lobe, and an annular side lobe is formed around the z-axis.

A full width at half maximum 2r_{B} and φ_{E} of the main lobe of a first type of zero-order Bessel beam are represented by equation (16) (Wei. Ting Chen, Mohammadreza Khorasaninejad, Alexander Y. Zhu, Jaewon Oh, Robert C. Devlin, Aun Zaidi, and Federico Capasso, “Generation of wavelength-independent subwavelength Bessel beams using metasurfaces,” Light & Application, 6, el6259, 2017.).

$$[ Math . 16 ]$$

$${φ}_{B} = {sin}^{- 1} \frac{2.252728}{2 {r}_{B} k} = {sin}^{- 1} \frac{2.252728}{4 {r}_{B} π} λ \qquad ( 16 )$$

In this way, OB is a parameter related to the diameter (full width at half maximum) 2rB of the beam on the z-axis. Here, k and λ are the wave number and wavelength of the propagating light (the emitted light of the diffractive element 10), respectively.

Next, the phase of the light on the z-axis is considered.

Since the length of 2π of the phase of light on the z-axis is 1/cos φ_{B} times (λ/cos φ_{B}) of the wavelength λ, the effective wave number k on the z-axis is cos QB times (kcos φ_{B}). Therefore, an absolute value of the phase of the light on the z-axis changes according to kcos φ_{B}.

Therefore, a relative difference between the phase of light at an arbitrary point on the z-axis and the phase at the intersection point between the DOE emission plane and the z-axis is—kzcos φ_{B}.

From the above, the electric field u₀ (x, y) on the DOE plane when forming a set of bright spots (bright lines) between zα and z_{β} on the z-axis is obtained, as shown in equation (15), by multiplying Exp [−jkz cos φ_{B}] by the electric field distribution u_{0, z} (x, y) on the emission plane for the spherical wave focused on a predetermined point on the z-axis, and by integrating (adding) the product over z_{α} to z_{β}. Here, Exp [x] represents the x-th power of the Napier number e.

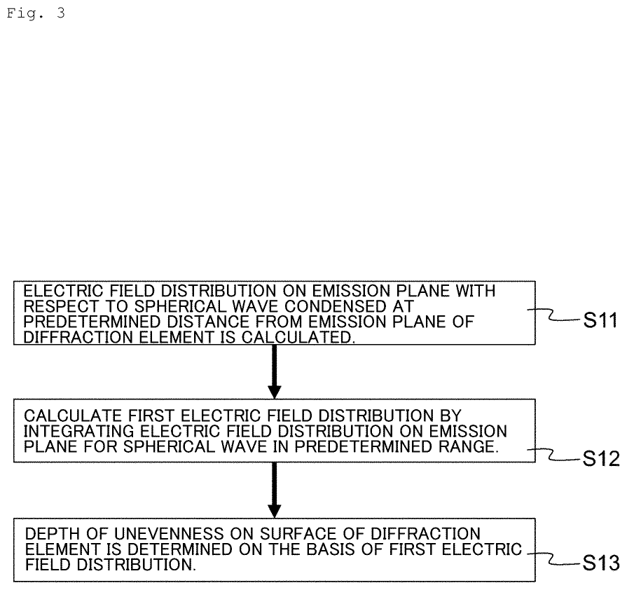

FIG. 3 shows a flow chart diagram for explaining a method for designing the diffractive element 10 according to the present embodiment.

Next, an electric field distribution on the emission plane with respect to a spherical wave condensed on the z-axis of a predetermined distance from the emission plane of the diffractive element 10 is calculated by equation (14) (step S11).

Next, in a predetermined range (Z_{α} to z_{β}), in the electric field distribution on the emission plane for each spherical wave bright spot, the first electric field distribution u₀ (x, y) is calculated by equation (15), taking into account the phase difference of −kzcos φ_{B} (step S12).

In the equation (15), when g (x, y)≐e^{-jkr} can be approximated, u₀ (x, y) is expressed by equation (17).

$$[ Math . 17 ]$$

$${u}_{0} ( x , y ) = {\int }_{{z}_{α}}^{{z}_{β}} {u}_{0 , z} ( x , y ) \cdot {e}^{- jkz cos {φ}_{B}} dz {\int }_{{z}_{α}}^{{z}_{β}} {e}^{jkr - jkz cos {φ}_{B}} dz \qquad ( 17 )$$

By using the electric field distribution u₀ (x, y) on the DOE emission plane obtained in this way, a thickness L (x, y) of the diffractive element 10 is calculated for each coordinate (x, y) on the DOE emission plane, from equations (18) and (19) (identical to each of equations (10), (11)), and the surface structure (unevenness shape) of the diffractive element 10 is designed (step S13).

$$[ Math . 18 ]$$

$$d ( x , y ) = \frac{arg ( {u}_{0} ( x , y ) )}{( {k}_{1} - {k}_{0} )} = \frac{λ}{2 π ( {n}_{1} - {n}_{0} )} arg ( {u}_{0} ( x , y ) ) \qquad ( 18 )$$

$$[ Math . 19 ]$$

$$L ( x , y ) = {L}_{0} - d ( x , y ) \qquad ( 19 )$$

In the present embodiment, the electric field distribution on the emission plane of the diffractive element is derived on the basis of the integrated value of the electric field distribution of the image formation between two points (Z_{α} and z_{β}) to design the surface structure (unevenness structure) of the diffractive element. Accordingly, the diameter and power of the bright line can be maintained to be substantially equal in a predetermined length (range) in the light propagation direction (z-direction). Here, “substantially equal” includes the same, and may be a range that can realize the accuracy required for laser processing using a beam, rust removal, and the like. For example, as will be described later, the beam diameter may vary within a range of about −10% to +13%, or the normalized beam power density may vary within a range of about 2.5 times. If this level of normalized beam power is used, for example, when the total power of the light emitted from the DOE emission plane is about 100 W which is a normally used rust removal laser power, rust removal is possible. The “standardized beam power density” is a beam power density when the total power of DOE emitted light is 1 W.

### Method for Manufacturing Diffractive Element

The diffractive element 10 is manufactured on the basis of the surface structure of the diffractive element 10 designed as described above. The diffractive element 10 is made of a plate member of a transparent material such as ZnS or quartz. The surface structure of the designed diffractive element 10 is formed on the surface of the plate member by known fine processing. Thus, the diffractive element 10 according to the present embodiment is manufactured.

### Effects

When a Bessel beam is applied to a conventional method for designing a diffractive element, since the Bessel beam has a constant beam diameter and intensity in an infinite range, the beam power does not attenuate, and therefore, there is a possibility that the Bessel beam is irradiated to a region other than a desired range. As a result, there is a problem that a desired shape cannot be processed, or there is a risk that an object other than the processing and rust removal target or a human body is irradiated with the beam.

In the diffractive element designed and manufactured in the present embodiment, the beam diameter and intensity can be limited to be constant in a finite range (for example, zα to zβ), and only a desired region can be irradiated. Therefore, the desired shape can be processed, and the safety can be secured without irradiating an object other than the processing and rust removal target or a human body.

Since the diffractive element designed and manufactured in the present embodiment can hold the diameter and power of the emitted light within a desired range in the propagation direction (z-direction) of the light, it is possible to process and remove rust with high accuracy on an object having a depth by the emitted light (laser beam).

Further, the diffractive optical element designed and manufactured in the present embodiment is small and light (about several tens of grams), and the head portion of the laser processing device can be made smaller and lighter than the conventional mechanism.

### Second Embodiment

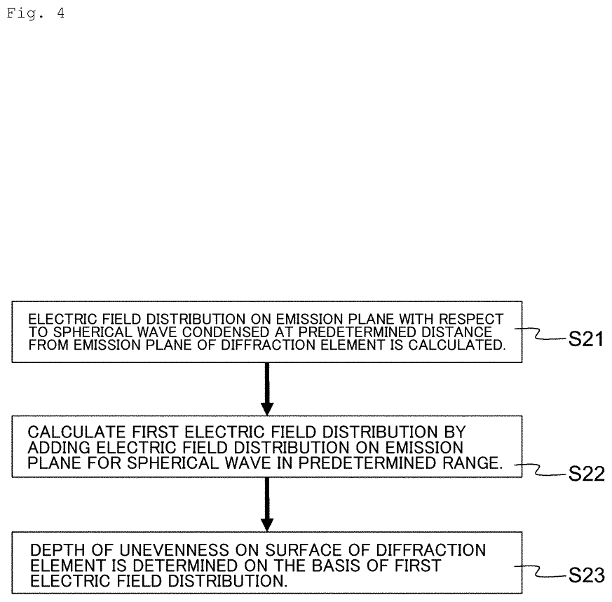

A method for designing a diffractive element and a method for manufacturing the same according to a second embodiment of the present invention will be described with reference to FIGS. 4 to 8B. FIG. 4 shows a flow chart for explaining a method for designing the diffractive element 20 according to the present embodiment.

In the first embodiment, integration was used as shown in equation (15) to calculate the electric field distribution u0 on the DOE emission plane.

In the present embodiment, in order to simplify the calculation of the electric field distribution u₀ by a computer, a method for discretely treating bright lines on an optical axis (z-axis) as a plurality of bright spots, summing up the electric field distributions u0, Zn obtained from the respective bright spots, and calculating the electric field distribution u0 (first electric field distribution) on the DOE emission plane will be described.

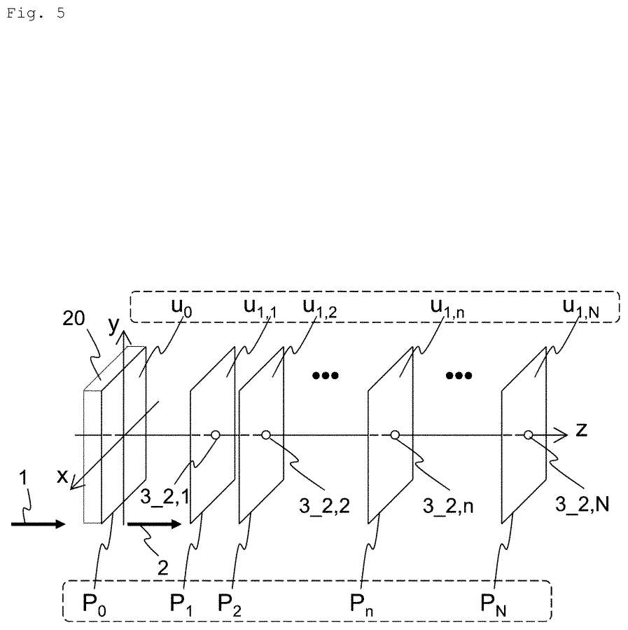

FIG. 5 is a schematic view of an optical system in a case where an image is formed, using a diffractive element 20 in the present embodiment. Light incident on the diffractive element 20 (an arrow 1 in the drawing indicates an incident direction) is emitted from the emission plane P0 of the diffractive element 20, and the emitted light of the diffractive element 20 (an arrow 2 in the drawing indicates an emission direction) is condensed as a plurality of (N) bright spots 3_2, 1 to 3_2, and N on the z-axis. Here, the emitted light has a first electric field distribution u0.

Each of the bright spots 3_2, 1 to 3_2, and N is assumed to be on N image formation planes Pₙ (here, n=1 to N, N is an integer of 2 or more). Pₙ (where n=1 to N) is each a plane, and parallel to the DOE emission plane (plane) P₀. Here, the image formation plane Pₙ is disposed in a predetermined range (z=z₁, to z_{N}).

When the center coordinates of the bright spot on Pₙ are defined as (0, 0, zₙ) (where n=1 to N), as in the first embodiment, the electric field distribution u_{0, zn} (x, y) on the DOE emission plane forming a bright spot centered at a point (0, 0, zₙ) on the z-axis is represented by equation (20).

$$[ Math . 20 ]$$

$${u}_{0 , {z}_{n}} ( x , y ) = {ℱ}^{- 1} [ \frac{1}{ℱ [ g ( x , y ) ]} ] \qquad ( 20 )$$

The electric field u0 (x, y) on the DOE emission plane on which a bright spot on the image formation plane Pₙ (n=1 to N) condenses is approximated by equation (21), from equation (20).

$$[ Math . 21 ]$$

$$\begin{matrix}{u}_{0} ( x , y ) = {\sum }_{n = 1}^{N} {u}_{0 , {z}_{n}} ( x , y ) \cdot {e}^{- {jkz}_{n} cos {φ}_{B}} \\ = {\sum }_{n = 1}^{N} {ℱ}^{- 1} [ \frac{1}{ℱ [ g ( x , y ) ]} ] \cdot {e}^{- {jkz}_{n} cos {φ}_{B}}\end{matrix} \qquad ( 21 )$$

In the equation (21), when g (x, y)=e≐^{-jkr} can be approximated, u₀ (x, y) is represented by the equation (22).

$$[ Math . 22 ]$$

$${u}_{0} ( x , y ) = {\sum }_{n = 1}^{N} {e}^{{jkr}_{n} - {jkz}_{n} cos {φ}_{B}} \qquad ( 22 )$$

Here, rₙ is represented by expression (23).

$$[ Math . 23 ]$$

$${r}_{n} = \sqrt{{x}^{2} + {y}^{2} + {z}_{n}^{2}} \qquad ( 23 )$$

As described above, in the method for designing the diffractive element 20 according to the present embodiment, as shown in FIG. 4, the electric field distribution on the emission plane with respect to the bright spot in the spherical wave condensed at each predetermined distance (N image formation planes disposed in a predetermined range) from the emission plane of the diffractive element 20 is calculated first (step S21).

Next, the electric field distribution on the emission plane with respect to the bright spot of the spherical wave on each of N image formation planes disposed in a predetermined range is added using equation (21) in consideration of the phase difference of −kzcos φ_{B}, and the first electric field distribution u0 (x, y) is calculated (step S22).

By using the electric field distribution u₀ (x, y) on the DOE emission plane obtained in this way, as in the first embodiment, the thickness L (x, y) of the diffractive element 20 is calculated for each coordinate (x, y) on the DOE emission plane from equations (18), (19), and the surface structure (unevenness shape) of the diffractive element 20 is designed (step S23).

The diffractive element 20 is manufactured in the same manner as in the first embodiment, on the basis of the surface structure of the diffractive element 20 designed in this manner.

### Effects

The effects of the method for designing the diffractive element and the method for manufacturing the same according to the present embodiment of the present invention will be described.

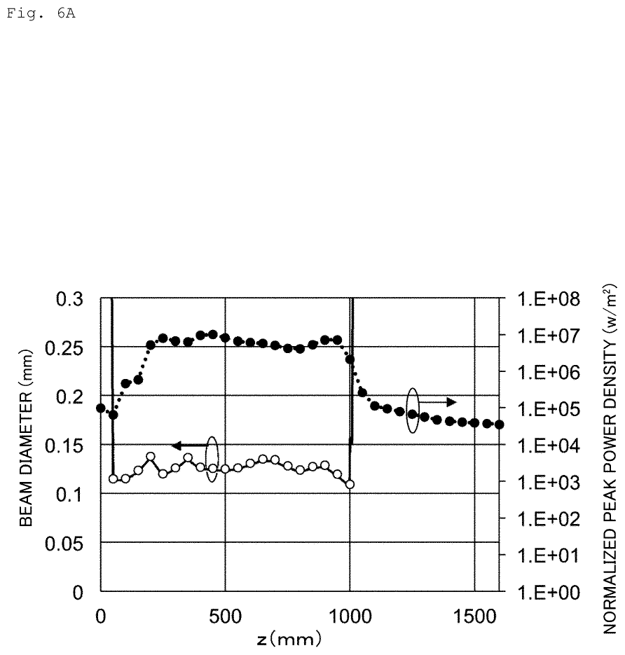

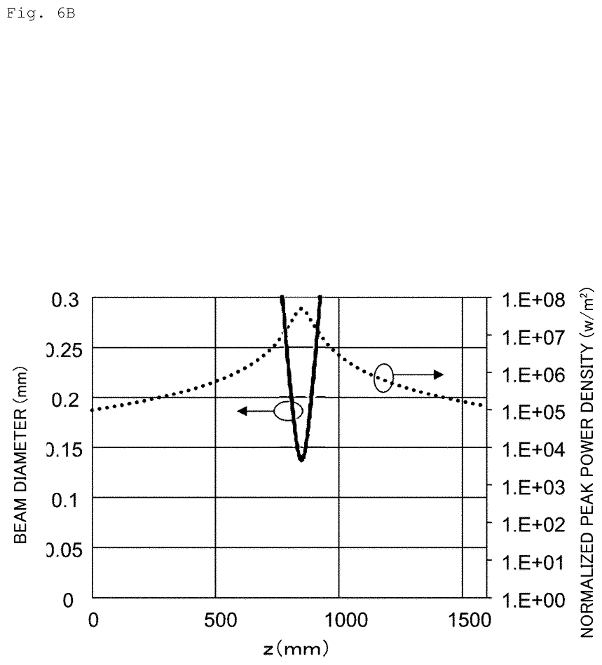

FIG. 6A is a simulation result of a beam diameter and a peak power density (maximum power density) of a light beam light intensity distribution (square of electric field intensity) when using the diffractive element 20 designed and manufactured in the present embodiment.

In the simulation of the light beam light intensity distribution, the range of bright lines is determined, and the electric field distribution u0 on the DOE emission plane is calculated by equation (21). The light beam light intensity distribution in the image formation was calculated on the basis of equation (1) using the electric field distribution u0.

Here, the bright spots were disposed on the z-axis at a distance z=5 μm to 1000 mm from the DOE emission plane.

An interval between adjacent image formation planes Pn and Pn+1 used when calculating the electric field distribution u0 on the DOE emission plane was set to 5 μm.

For comparison, FIG. 6B shows a simulation result of full width at half maximum and peak power density (maximum power density) of theoretical Gaussian beam, when using a lens as a conventional method. The focal length is set to 849 mm so that the beam diameter in the beam waist is almost the same as that in the case of using the diffractive element 20. A horizontal axis z in the drawing indicates a distance from a lens emission side principal point.

The beam incident on the diffractive element (DOE) 20 and the lens used in the simulation was a Gaussian beam with a diameter of 5.1 mm (a diameter at which the power density is 1/e2 of the peak power density).

In the drawing, the “distance z” on the horizontal axis is a distance from the DOE emission plane. The “normalized peak power density” on the vertical axis is a peak power density when the total power of DOE emitted light is 1 W.

Although the “beam diameter” of the vertical axis is usually a diameter which becomes a power density of 1/e2 of the peak power density, because the light beam light intensity distribution determined by the electric field distribution u0 on the DOE emission plane in the present embodiment is not a Gaussian type, the full width at half maximum (FWHM) was used.

In an optical system using a Gaussian beam using a conventional lens, as shown in FIG. 6B, a beam with a diameter of about 126 μm is held only in a length of 75.6 mm with a beam diameter change in a range of about 133 μm to 189 μm.

On the other hand, in the present embodiment, as shown in FIG. 6A, a beam with a diameter of about 126 μm is held at a length of 950 mm between 50 mm and 1000 mm with a beam diameter change in the range of −10% to +13%.

As described above, according to the design method of the present embodiment, it is possible to design the diffractive element capable of holding the beam diameter at a distance of about thirteen times as long as that of the conventional optical system using a lens.

As for the peak power density of the light beam which is important in rust removal and processing, in the conventional optical system using the lens, the range in which the fluctuation of the maximum power density of the light beam is within about 2.5 times is a length of 84.2 mm.

On the other hand, in the present embodiment, the range in which the variation of the maximum power density of the light beam is within about 2.5 times is 750 mm in length between z=200 mm and 950 mm.

As described above, according to the design method of the present embodiment, it is possible to design the diffractive element capable of holding the maximum power density of the light beam, by suppressing fluctuations in the maximum power density of the light beam by about 9 times compared to the conventional optical system using the lens, for the maximum power density of the light beam.

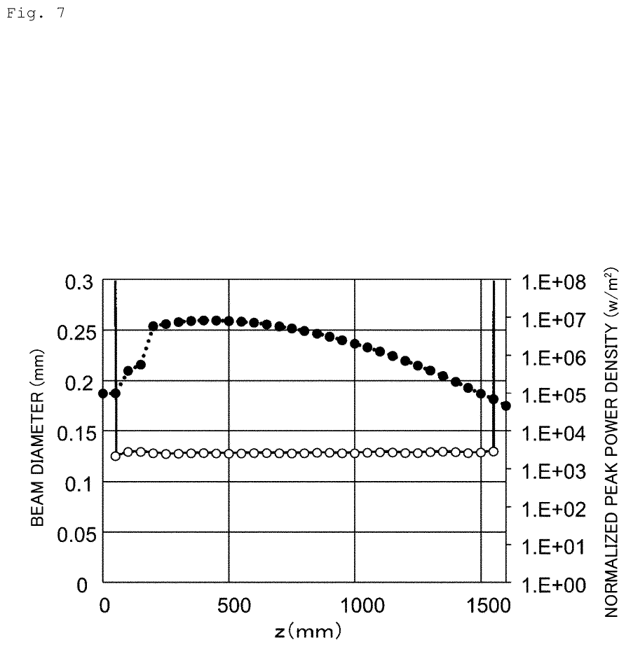

FIG. 7 shows the simulation results of the full width at half maximum and the peak power density (maximum power density) of the Bessel beam which is one of non-diffracted light in the case of using an axicon lens as a conventional method. The calculation was performed similarly to the above-mentioned simulation (FIGS. 6A and 6B).

In an optical system using a Bessel beam using a conventional lens, a beam with a diameter of about 126 μm is held at a length of 1500 mm with a beam diameter change in the range of −2.5% to +1.2%.

As for the peak power density of the light beam which is important in rust removal and processing, in the conventional optical system using the lens, the range in which the fluctuation of the maximum power density of the light beam is within about 2.5 times is a length of 650 mm. Further, it gradually decreases with an increase in the distance z, and is approximately 1E+5W/m² at z=1500 mm.

On the other hand, in the present embodiment, as shown in FIG. 6A, the beam diameter is held as described above, and the maximum power density of the light beam is maintained between z=200 mm and 950 mm. Furthermore, it decreases rapidly at z=950 mm or more, and is about 0.5E+5W/m² at z=1500 mm.

In this way, according to the present embodiment, rust removal and processing (welding and cutting) can be performed within a desired range, the peak power density is rapidly lowered outside the desired range (for example, z=950 mm or more). Accordingly, the influence on a person and an object can be reduced, and the safety of work can be improved.

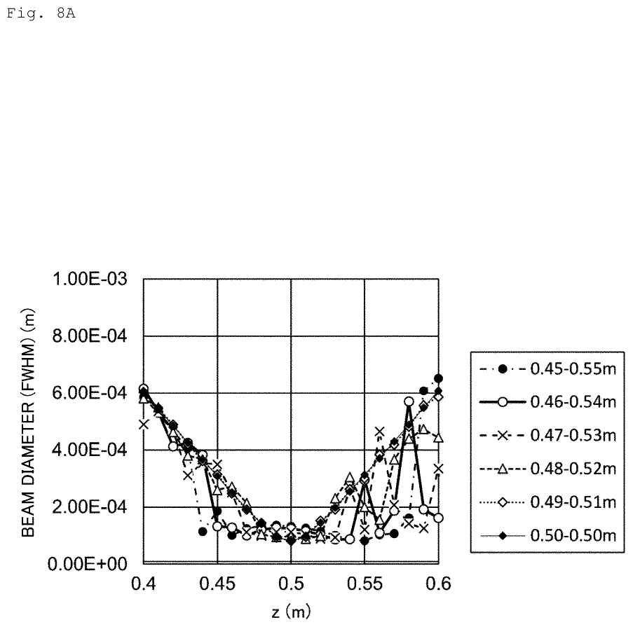

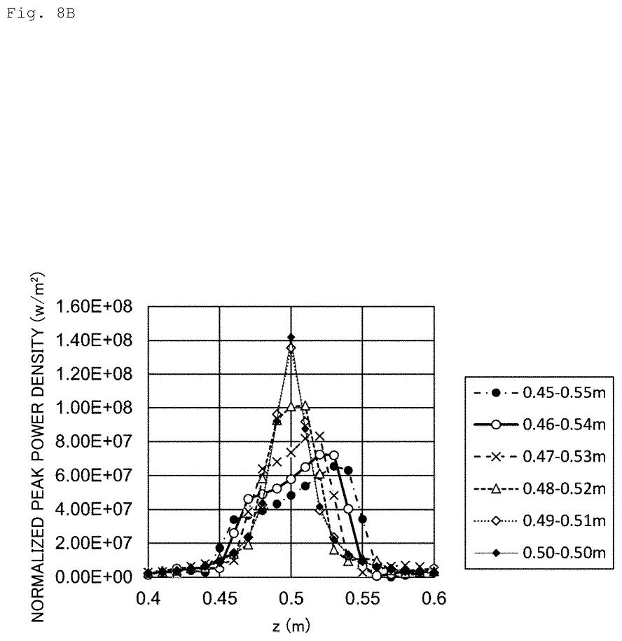

FIGS. 8A and 8B show the simulation results of the change of the beam diameter (FWHM) and the normalized peak power density on the z-axis with respect to the bright spot placement range on the z-axis at the time of designing the diffractive element 20 in the present embodiment. The bright spot placement range on the z-axis is +/−0 mm (0.5m), +/−10 mm (0.49 to 0.51 m), +/−20 mm (0.48 to 0.52 m), +/−30 mm (0.47 to 0.53 m), +/−40 mm (0.46 to 0.54 m), and +/−50 mm (0.45 to 0.55 m) centered around 500 mm (0.5 m). The calculation was performed in the same manner as described above.

For example, when the bright spot placement range on the z-axis when designing the diffractive element is set to +/−40 mm (0.46 to 0.54 m), the beam diameter of the light emitted from the diffractive element is about 1.5 E-4 m in the range of 0.46 to 0.54 m, and is almost constant. In addition, the normalized peak power density is about 3 E+7 to 7 E+7 in the range of 0.46 to 0.54 m, and the fluctuation in the maximum power density of the light beam is within about 2.5 times. Even in the case where another bright spot placement range is set, similarly, the beam diameter of the light is almost constant in the set bright spot placement range, and the fluctuation of the maximum power density of the light beam is within the allowable range.

As described above, according to the present embodiment, the beam diameter holding range and the peak power density holding range can be realized as the bright spot placement range is set when designing the diffractive element.

As described above, according to the present embodiment, the electric field distribution on the emission plane of the diffractive element is derived on the basis of the total value of the electric field distribution on the emission plane of the diffractive element for generating each image formation on a plurality (N) of image formation planes arranged in a predetermined range, and the surface structure (unevenness structure) of the diffractive element is designed. Accordingly, it is possible to hold the diameter and the maximum power density of the light beam emitted from the diffractive element almost equally in a predetermined length (range) in the propagation direction (z-direction) of the light.

Therefore, since the diffractive element manufactured in the present embodiment can hold the diameter and maximum power density of the emitted light at a desired length in the propagation direction (z-direction) of the light, it is possible to process targets with depth with high precision using emitted light (laser beam) and remove rust, and the same effect as that of the first embodiment can be obtained.

In addition, in the diffractive element manufactured in the present embodiment, the beam diameter and intensity can be limited to be constant in a finite range (for example, zα to zβ), and only a desired region can be irradiated. Therefore, the desired shape can be processed, and the safety can be secured without irradiating an object other than the processing and rust removal target or a human body.

### Third Embodiment

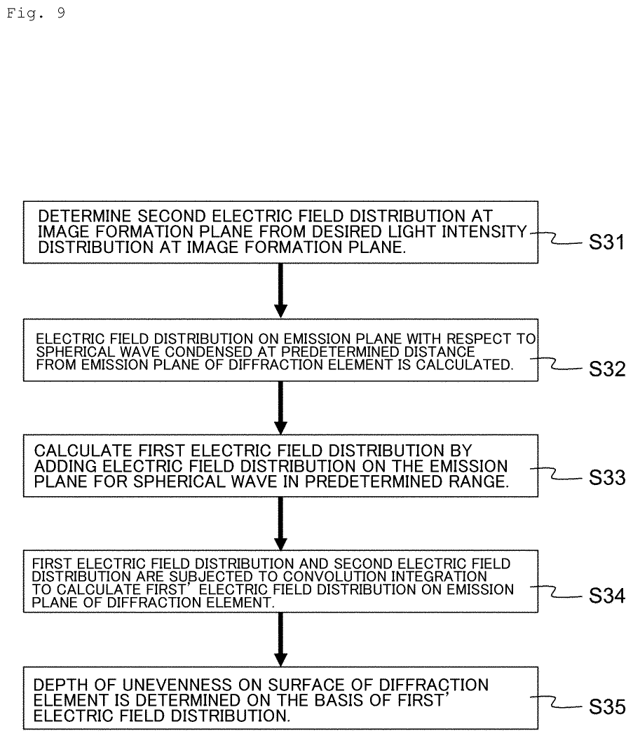

A method for designing a diffractive element and a method for manufacturing the same according to a third embodiment of the present invention will be described with reference to FIG. 9.

In the first and second embodiments, DOE in which a bright spot is formed is shown as an example. In the present embodiment, a DOE for forming a desired image will be described as an example.

In detail, in the first embodiment, the electric field distribution on the DOE emission plane in which each light intensity distribution on a plane parallel to P₀ in a range of z_{α} to z_{β} (z is Z_{α} or more and z_{β} or less) is substantially equal is shown.

Also in the second embodiment, similarly, the electric field distribution on the DOE emission plane in which the light intensity distributions on the image formation plane Pₙ (N=1 to N) are substantially equal to each other is shown.

In the present embodiment, a diffractive element (DOE) 30 for forming a two-dimensional shape on the image formation plane will be described. The diffractive element 30 performs phase modulation so that light emitted from the emission plane in a first' electric field distribution has an intensity distribution of a second electric field distribution corresponding to a desired light intensity distribution on the image formation plane.

FIG. 9 shows a flow chart diagram for explaining a method for designing the diffractive element 30 according to the present embodiment.

First, the light intensity distribution to be imaged on the image formation plane Pₙ (n=1 to N) is set to q (x, y) (that is, the light intensity distribution to be imaged on all the image formation planes Pₙ (n=1 to N) is the same q (x, y)). The electric field intensity at this time becomes √q (x, y), but the electric field distribution (second electric field distribution) having this electric field intensity is set as u_{c} (x, y) (step S31). In u_{c} (x, y), for example, the real part of the electric field may be set as √q (x, y), the imaginary part may be set as o, and u_{c} (x, y)=√q (x, y)+j·0 may be established. Here, j represents the imaginary unit.

Next, an electric field distribution on the emission plane with respect to a spherical wave condensed on the z-axis of a predetermined distance from the emission plane of the diffractive element 30 is calculated (step S32).

Next, in a predetermined range (for example, Z_{α} to z_{β}), the electric field distribution on the emission plane with respect to each spherical wave calculated in step S32 is added in consideration of a change in the phase of light in the propagation direction of the light, and a first electric field distribution u0 (x, y) is calculated (step S33). Here, “addition of electric field distributions” includes integration of electric field distributions in a predetermined range, and refers to calculation of the total sum of the electric field distributions in the predetermined range.

The steps S32 and S33 are the same as the method for calculating the electric field distribution u0 on the DOE emission plane in the first and second embodiments, and are calculated by equation (15), Equation (17), equation (21), and equation (22).

Next, the electric field distributions u0, 1 (first' electric field distribution) on the DOE emission plane are calculated by performing convolution integration of the first electric field distribution u₀ (x, y) and the second electric field distribution uc (x, y) (step S34), as shown in equation (24). Here, the first electric field distribution ulo (x, y) is an electric field distribution on the DOE emission plane with respect to a spherical wave condensed in a predetermined range on an optical axis.

$$[ Math . 24 ]$$

$${u}_{0 , l} ( x , y ) = \int {\int }_{S} {u}_{c} ( ξ , η ) {u}_{0} ( x - ξ , y - η ) d ξ d η \qquad ( 24 )$$

Here, S represents an integration range, and a range on the DOE emission plane or a range including the DOE emission plane is considered.

Here, the shape represented by u_{c} (x, y) may be a bright spot as shown in the first embodiment. Therefore, the electric field distributions u₀, 1 (x, y) on the DOE emission plane in the present embodiment includes the electric field distribution u₀ (x, y) on the DOE emission plane in the first embodiment.

The depth d (x, y) of the unevenness on the surface of the diffractive element 30 is calculated by equation (25), using electric field distributions u₀, 1 (x, y) on the DOE emission plane obtained in this way.

$$[ Math . 25 ]$$

$$d ( x , y ) = \frac{λ}{2 π ( {n}_{1} - {n}_{0} )} arg ( {u}_{0 , l} ( x , y ) ) \qquad ( 25 )$$

Here, n1 is a refractive index inside the diffractive element 30, no is a refractive index outside the diffractive element 30, λ is a wavelength of propagating light (emitted light of the diffractive element 30), and arg (u_{0, 1} (x, y)) is a deflection angle of the electric field distribution u_{0, 1} (x, y).

The thickness L (x, y) of the diffractive element 30 is calculated for each coordinate (x, y) on the DOE emission plane by equation (19) using d (x, y) to design the surface structure (unevenness shape) of the diffractive element 30 (step S35).

The diffractive element 30 is manufactured in the same manner as in the first embodiment, on the basis of the surface structure of the diffractive element 30 designed in this manner.

Further, in the present embodiment, if u_{c} (ξ, n) is a line segment, a line segment image is formed when the rust is removed by using a laser, and rust removal can be performed as a plane by moving the image in a direction perpendicular to the line segment.

As described above, according to the present embodiment, it is possible to keep the diameter and power of the light beam emitted from the diffractive element to be substantially equal within a predetermined length (range) in the light propagation direction (z-direction), by deriving the electric field distribution on the emission plane of the diffractive element and designing the surface structure (unevenness structure) of the diffractive element, on the basis of convolution integration of the total value of the electric field distributions on the diffractive element for imaging each bright spot of the bright line within a predetermined range of a straight line passing through the diffractive element (the electric field distribution on the diffractive element emission plane for generating the bright line) and the electric field distributions of various shapes.

Therefore, since the diffractive element manufactured in the present embodiment can hold the diameter and power density of the emitted light at a desired length in the propagation direction (z-direction) of the light, it is possible to perform highly accurate processing and rust removal of various shapes using emitted light (laser beam) on targets with depth, and the same effect as that of the first embodiment can be obtained.

In the embodiment of the present invention, the emitted light from the diffractive element is condensed in a direction parallel to the optical axis, but the present invention is not limited thereto, but may be on an axis substantially parallel to the optical axis instead of on an axis parallel to the optical axis. The “substantially same axis” may be within a range in which accuracy necessary for laser beam machining using a beam, rust removal, and the like can be realized.

In an embodiment of the present invention, equations that express the electric field distribution as an integral (e.g., equations (15) and (17)) include expressions that express the electric field distribution as the sum of multiple discrete bright spots (e.g., equations (21) and (22)).

In the embodiment of the present invention, the diffractive element is designed using a computer.

In the embodiment of the present invention, an example of the structure, dimensions, material, and the like of each constituent part is shown in the configuration of the diffractive element, the manufacturing method, and the like, but the present invention is not limited thereto. Any material can be used as long as it exhibits the function of a diffractive element and produces an effect.

### INDUSTRIAL APPLICABILITY

Embodiments of the present invention relate to a method for designing a diffractive element and a method for manufacturing the same in a high power laser device, and is applicable to processing and rust removal by a laser beam.

### REFERENCE SIGNS LIST

10 Diffractive element

1-6. (canceled)

7. A method for designing a diffractive element which phase-modulates incident light using a computer, the method comprising:
determining an electric field distribution on an emission plane with respect to a spherical wave condensed in a range between a first distance and a second distance from the emission plane, on a straight line perpendicular to the emission plane of the diffractive element;
calculating a first electric field distribution as the electric field distribution on the emission plane of the diffractive element, by multiplying Exp [−jkz cos φ_{B}] when a coordinate on a straight line is z, the wave number of an emitted light from the emission plane is k, and a convergence angle that the emitted light makes with the straight line is φ_{B} by the electric field distribution on the emission plane for the spherical wave, and by integrating over the range; and
determining a depth of an unevenness on a surface of the diffractive element on the basis of the electric field distribution on the emission plane of the diffractive element.

8. A method for designing a diffractive element which phase-modulates incident light using a computer, the method comprising:
determining an electric field distribution on an emission plane with respect to a spherical wave condensed in a range between a first distance and a second distance from the emission plane, on a straight line perpendicular to the emission plane of the diffractive element;
calculating a first electric field distribution as the electric field distribution on the emission plane of the diffractive element, by multiplying Exp [−jkz cos φ_{B}] when a coordinate on a straight line is z, the wave number of an emitted light from the emission plane is k, and a convergence angle that the emitted light makes with the straight line is φ_{B} by the electric field distribution on the emission plane for the spherical wave, and by adding over the range; and
determining a depth of an unevenness on a surface of the diffractive element on the basis of the electric field distribution on the emission plane of the diffractive element.

9. The method for designing the diffractive element according to claim 7, further comprising:
calculating a second electric field distribution which has a positive square root of the light intensity distribution imaged on a plane perpendicular to the straight line disposed in the range, as an intensity; and
calculating the electric field distribution on the emission plane of the diffractive element, by performing convolution integration of the second electric field distribution and the first electric field distribution.

10. The method for designing the diffractive element according to claim 7,
wherein the first electric field distribution u₀ (x, y) is calculated by equation (A):
$$\begin{matrix}{u}_{0} ( x , y ) = {\int }_{{z}_{α}}^{{z}_{β}} {u}_{0 , z} ( x , y ) \cdot {e}^{- jkz cos φ} dz \\ = {\int }_{{z}_{α}}^{{z}_{β}} {ℱ}^{- 1} [ \frac{1}{ℱ [ g ( x , y ) ]} ] \cdot {e}^{- jkz cos φ} dz\end{matrix} \qquad ( A )$$
here, u_{0′z} (x, y) are the electric field distribution on the emission plane with respect
to the spherical wave condensed at the predetermined point, and z_{α} and z_{β} are
the first distance and the second distance, respectively, further, ϕ is expressed by the following equation.
$$φ = {sin}^{- 1} \frac{2.252728}{2 {r}_{B} k} = {sin}^{- 1} \frac{2.252728}{4 {r}_{B} π} λ$$
Here, 2r_{B} is a diameter of the Bessel beam, and λ is a wavelength of the emitted light.

11. The method for designing the diffractive element according to claim 7,
wherein the depth d(x, y) of the unevenness on the surface of the diffractive element is expressed by equation (B).
$$d ( x , y ) = \frac{λ}{2 π ( {n}_{1} - {n}_{0} )} arg ( {u}_{0 , l} ( x , y ) ) \qquad ( B )$$
Here, n, is a refractive index inside the diffractive element, no is a refractive index outside the diffractive element, λ is a wavelength of emitted light, and arg (u_{0, 1} (x, y)) is a deflection angle of the electric field distribution on the emission plane of the diffractive element.

12. The method of claim 7 further comprising:
manufacturing the diffractive element.

13. The method for designing the diffractive element according to claim 8, further comprising:
calculating a second electric field distribution which has a positive square root of the light intensity distribution imaged on a plane perpendicular to the straight line disposed in the range, as an intensity; and
calculating the electric field distribution on the emission plane of the diffractive element, by performing convolution integration of the second electric field distribution and the first electric field distribution.

14. The method for designing the diffractive element according to claim 8,
wherein the first electric field distribution u₀ (x, y) is calculated by equation (A):
$$\begin{matrix}{u}_{0} ( x , y ) = {\int }_{{z}_{α}}^{{z}_{β}} {u}_{0 , z} ( x , y ) \cdot {e}^{- jkz cos φ} dz \\ = {\int }_{{z}_{α}}^{{z}_{β}} {ℱ}^{- 1} [ \frac{1}{ℱ [ g ( x , y ) ]} ] \cdot {e}^{- jkz cos φ} dz\end{matrix} \qquad ( A )$$
here, u_{0′z} (x, y) are the electric field distribution on the emission plane with respect
to the spherical wave condensed at the predetermined point, and z_{α} and z_{β} are
the first distance and the second distance, respectively, further, ϕ is expressed by the following equation.
$$φ = {sin}^{- 1} \frac{2.252728}{2 {r}_{B} k} = {sin}^{- 1} \frac{2.252728}{4 {r}_{B} π} λ$$
Here, 2r_{B} is a diameter of the Bessel beam, and λ is a wavelength of the emitted light.

15. The method for designing the diffractive element according to claim 8,
wherein the depth d(x, y) of the unevenness on the surface of the diffractive element is expressed by equation (B).
$$d ( x , y ) = \frac{λ}{2 π ( {n}_{1} - {n}_{0} )} arg ( {u}_{0 , l} ( x , y ) ) \qquad ( B )$$
Here, n₁ is a refractive index inside the diffractive element, no is a refractive index outside the diffractive element, λ is a wavelength of emitted light, and arg (u_{0, 1} (x, y)) is a deflection angle of the electric field distribution on the emission plane of the diffractive element.

16. The method of claim 8 further comprising:
manufacturing the diffractive element.

17. The method of claim 12, wherein manufacturing the diffractive element comprises:
providing a plate member of a transparent material;
forming a surface structure on the plate member by fine processing, wherein the surface structure corresponds to the depth of the unevenness determined for the diffractive element; and
wherein the transparent material is selected from the group consisting of ZnS and quartz.

18. The method of claim 16, wherein manufacturing the diffractive element comprises:
providing a plate member of a transparent material;
forming a surface structure on the plate member by fine processing, wherein the surface structure corresponds to the depth of the unevenness determined for the diffractive element; and
wherein the transparent material is selected from the group consisting of ZnS and quartz.
